(19) United States
(12) Patent Application Publication
(10) Pub. No.: US 2008/0137725 A1
(43) Pub. Date: Jun. 12, 2008

(54) SYSTEMS AND METHODS FOR DISPLAYING LOCAL MEDIA SIGNAL AND BROADCAST SIGNAL UTILIZING ONE DECODER

(76) Inventors: Yu-Chieh Chou, Hsinchu City (TW); Yu-Ching Hsieh, Taipei City (TW)

Correspondence Address: NORTH AMERICA INTELLECTUAL PROPERTY CORPORATION, P.O. BOX 506, MERRIFIELD, VA, 22116, US

(21) Appl. No.: 11/609,332

(22) Filed: Dec. 12, 2006

(51) Int. Cl. H04N 11/02; H04N 5/45

(52) U.S. Cl. 375/240.01; 348/565; 375/E07.076; 348/E05.112

(57) ABSTRACT

A system for displaying a first data signal and a second data signal is disclosed. The system includes: a decoder, for selectively decoding the first data stream to output a first decoded signal or the second data stream to output a second decoded signal according to a command signal; and a frame buffer, for receiving the first decoded signal or the second decoded signal to output a first video signal or a second video signal respectively; wherein when the decoder stops outputting the first decoded signal and starts outputting the second decoded signal, the frame buffer will buffer a last received frame of the first decoded signal, and when the decoder stops outputting the second decoded signal and starts outputting the first decoded signal, the frame buffer will buffer a last received frame of the second decoded signal.

### BACKGROUND

The disclosed system relates to a digital displaying system, and more particularly, to a digital displaying system that supports display of a broadcast signal and a local media signal utilizing a single decoder.

Picture in Picture (PIP) and Picture of Picture (POP) are features of digital technology that allow two or more video signals to be simultaneously displayed on a display screen. Conventionally, these video signals are broadcast signals—for example, a first screen area displays a sports program while a second screen area displays advertisements. As both signals are broadcast signals, i.e. live video signals requiring simultaneous decoding, such a displaying system requires two decoders and two tuners.

### SUMMARY

If one of the broadcast signals were replaced with a local media signal, e.g. a DVD source, a display system may only require one decoder and one tuner.

With this in mind, a system that supports decoding of at least a local media data signal and a broadcast data signal is disclosed. The system advantageously only requires one decoder. By utilization of a time shift feature, the broadcast signal can be buffered when it is not being viewed, so playback can be resumed without the loss of data.

The disclosed system comprises: a decoder, coupled to a first data stream and a second data stream, for selectively decoding the first data stream to output a first decoded signal or decoding the second data stream to output a second decoded signal according to a command signal; and a frame buffer, coupled to the decoder, for receiving the first decoded signal or the second decoded signal from the decoder to output a first video signal or a second video signal respectively; wherein when the decoder stops outputting the first decoded signal and starts outputting the second decoded signal, the frame buffer will buffer a last received frame of the first decoded signal, and when the decoder stops outputting the second decoded signal and starts outputting the first decoded signal, the frame buffer will buffer a last received frame of the second decoded signal.

A method thereof is also disclosed, comprising: selectively decoding a first data stream to output a first decoded signal or decoding a second data stream to output a second decoded signal according to a command signal; outputting a first video signal or a second video signal corresponding to the first decoded signal or the second decoded signal respectively; and buffering a last frame of the first video signal when the second video signal is output, and buffering a last frame of the second video signal when the first video signal is output.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a system according to one embodiment of the present invention.

FIG. 2 is a diagram illustrating an exemplary displaying screen shown in FIG. 1.

FIG. 3 is a flowchart illustrating an exemplary operation of the present invention.

FIG. 4 is a flowchart illustrating another exemplary operation of the present invention.

### DETAILED DESCRIPTION

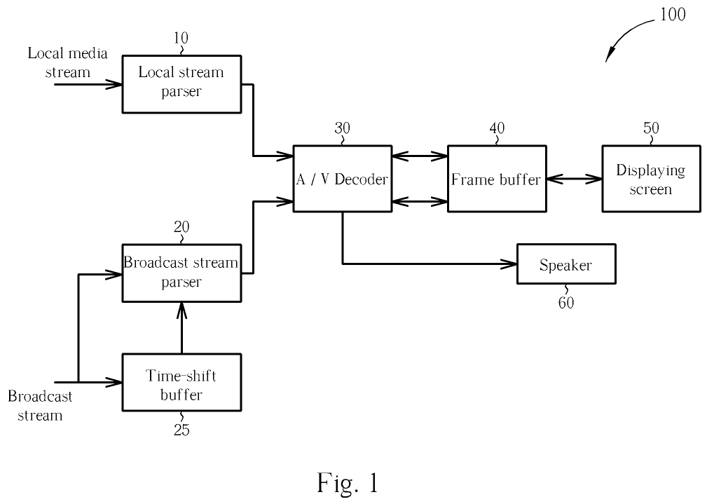

Please refer to FIG. 1. FIG. 1 is a diagram of a system 100 according to one embodiment of the present invention. The system 100 comprises an A/V (audio and video) decoder 30, for selectively receiving and decoding a first data stream or a second data stream according to a command signal. As shown in FIG. 1, the A/V decoder 30 is coupled to a local stream parser 10 for parsing the first data stream (a local media stream, e.g. a DVD data stream) and further coupled to a broadcast stream parser 20 for parsing the second data stream (a broadcast stream, e.g. a DVB data stream). The A/V decoder 30 is further coupled to a frame buffer 40, for buffering each frame of decoded video data to be displayed. The broadcast stream parser 20 is coupled to a time-shift buffer 25, for buffering the broadcast stream. The frame buffer 40 is coupled to a displaying screen 50. Please note that, in this embodiment, the system 100 only supports one broadcast stream and one local media stream. The number of local media streams is not limited to one, however, and a system that supports a plurality of local media streams also falls within the scope of the present invention. Additionally, it should be noted that the local media stream is a stored data stream, while the broadcast stream is a live data stream.

The following description focuses on video display; however, as will be readily apparent to a person skilled in this art, support for audio playback using the speaker 60 can be implemented according to the disclosed teachings. For example, in a case where the local media stream and the broadcast stream are a stored audio stream and a live audio stream respectively, the system can be easily configured to achieve the desired goal of using a single decoder for audio playback of a local audio stream and a broadcast audio stream. This also obeys the spirit of the present invention.

When no local media stream is to be played back, for example, no DVD is inserted, the broadcast stream will be directly received by the broadcast stream parser 20. The parsed stream is sent to the A/V decoder 30 where it is decoded and output to the displaying screen 50. The broadcast stream is displayed on a first screen area (not shown in FIG. 1) of the displaying device 50. When the DVD is inserted, a user has the option to pause the broadcast stream and start to view the DVD data on a second screen area. In this case, a command signal will be sent, for example, via a remote control. The command signal is for instructing the system 100 to stop sending the broadcast stream to the A/V decoder 30 and to start sending the local media stream to the A/V decoder 30. At this point the time-shift buffer 25 will be enabled, for buffering the broadcast stream, which is a live data stream. At the same time, the frame buffer 40 will buffer a last received frame of the broadcast stream. This last received frame will further be displayed on the first screen area of the displaying screen 50. In some embodiments, the user can select the display screen 50 to show both the first and second screen areas, or he can select to show only one of the screen areas in full scale.

If the user then determines to stop viewing the local media stream displayed on a second careen area (not shown in FIG. 1) and resume viewing the broadcast stream, the command signal will be sent one more time. At this point, the system 100 will stop sending the local media stream to the A/V decoder 30, and resume sending the broadcast stream to the A/V decoder 30. In this case, however, the user can choose to watch the real-time broadcast stream or the broadcast stream temporally stored in the time-shift buffer 25. The utilization of the frame buffer 40 serves as a reference point for determining the point at which to resume playback. The local media stream does not need to be buffered, as it already exists in a stored form. The frame buffer 40 will still buffer the last received frame of the local media stream, however, and can further display the last received frame on the second screen area of the displaying screen 50. If the user wishes to stop viewing the broadcast stream and resume viewing the local media stream, the buffered frame in the frame buffer 40 will similarly be utilized as a reference point for determining where to resume playback of the local media stream.

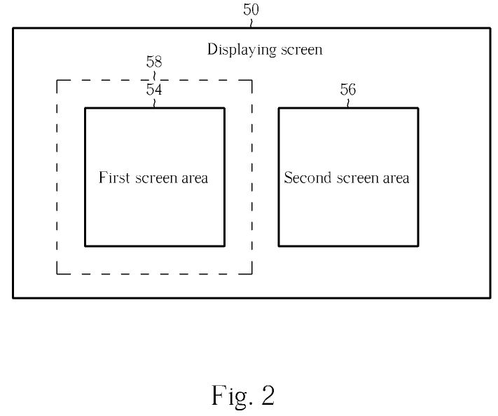

The command signal will now be described in more detail. Please refer to FIG. 2. FIG. 2 is a diagram of the displaying screen 50 of FIG. 1. The disclosed displaying screen 50 comprises a first screen area 54 for displaying the local media stream, and a second screen area 56 for displaying the broadcast stream. Please note that the first screen area 54 and the second screen area 56 may be PIP or POP configuration, and both embodiments fall within the scope of the present invention. The displaying screen 50 further shows a focus 58, which is utilized to highlight one of the screen areas 54 and 56. If the first screen area 54 is highlighted, the command signal will instruct the system 100 to send the local media stream to the A/V decoder 30, and if the second screen area 56 is highlighted, the command signal will instruct the system 100 to send the broadcast stream to the A/V decoder 30. The movement of the focus 58 can be a user command, for example a remote control comprises a key for moving the focus 58 between the first screen area 54 and the second screen area 56. A user can also set a timer for switching the focus 58 between the first screen area 54 and the second screen area 56. If the user wishes to watch a live television program but wishes to enjoy a DVD in the meantime, the setting of the focus 58 advantageously prevents the user from forgetting to change the media source. Furthermore, to aid convenience, the focus 58 can also be moved from the second screen area 56 to the first screen area 54 when a local media source is inserted, and similarly moved from the first screen area 54 to the second screen area 56 when the local media source is removed/disconnected.

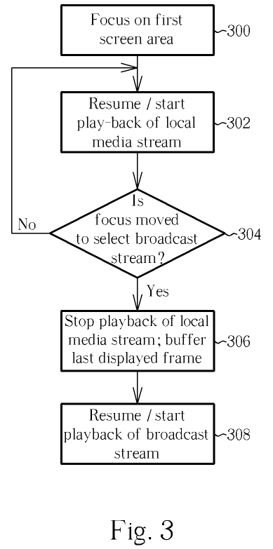

For a clearer description of the operation of the disclosed system, please refer to FIG. 3, which is a flowchart illustrating an exemplary operation of the present invention. The steps are as follows:

Step 300: Focus on first screen area;

Step 302: Resume/start playback of local media stream;

Step 304: Is focus moved to select broadcast stream? If yes go to Step 306, if no go back to Step 302 and continue playback of local media stream;

Step 306: Stop playback of local media stream and buffer last displayed frame;

Step 308: Resume/start playback of broadcast stream.

When the focus 58 is on the first screen area 54, i.e. the screen area corresponding to the local media stream (step 300), playback of the local media stream will be started/resumed (step 302). If the focus 58 is then moved to the second screen area 56, i.e. the screen area corresponding to the broadcast stream (step 304), playback of the local media stream will be stopped, and a last displayed frame of the local media stream will be buffered in the frame buffer 40 (step 306). Finally, playback of the broadcast stream will be resumed/started (step 308).

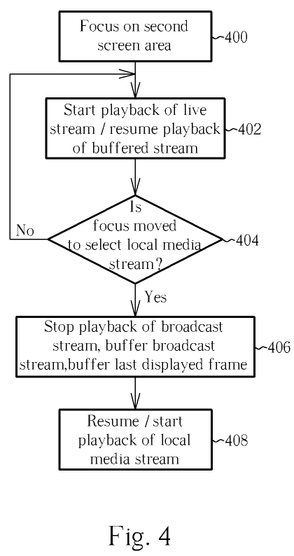

Please refer to FIG. 4. FIG. 4 is a flowchart illustrating another operation of the present invention. The steps are as follows:

Step 400: Focus on second screen area;

Step 402: Start playback of live stream/resume playback of buffered stream;

Step 404: Is focus moved to select local media stream? If yes go to Step 406, if no go back to Step 402 and continue playback of broadcast stream;

Step 406: Stop playback of broadcast stream, buffer broadcast stream, and buffer last displayed frame;

Step 408: Resume/start playback of local media stream.

When the focus 58 is on the second screen area 56, i.e. the screen area corresponding to the broadcast stream (step 400), playback of the live broadcast stream will be started, or playback of the broadcast stream buffered in the time-shift buffer 25 will be resumed (step 402). If the focus 58 is then moved to the first screen area 54, i.e. the screen area corresponding to the local media stream (step 404), playback of the broadcast stream will be stopped, the broadcast stream will be buffered in the time-shift buffer 25, and a last displayed frame of the broadcast stream will be buffered in the frame buffer 40 (step 406). Finally, playback of the local media stream will be resumed/started (step 408).

The disclosed system enables a mechanism that can switch between playback of a local media data stream and a broadcast data stream without incurring the loss of data. The system further provides a focus that can actively switch between the two data streams, or can be programmed to switch between the two data streams at a predetermined time.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A system for selectively playing a first data stream or a second data stream, the system comprising:
a decoder, coupled to both the first data stream and the second data stream, for selectively decoding the first data stream to output a first decoded signal or decoding the second data stream to output a second decoded signal according to a command signal; and
a frame buffer, coupled to the decoder, receiving the first decoded signal or the second decoded signal from the decoder for outputting a first video signal or a second video signal accordingly;
wherein when the decoder stops outputting the first decoded signal and starts outputting the second decoded signal, the frame buffer will buffer a last received frame of the first decoded signal, and when the decoder stops outputting the second decoded signal and starts outputting the first decoded signal, the frame buffer will buffer a last received frame of the second decoded signal.

2. The system of claim 1, further comprising:
a displaying device, coupled to the frame buffer, comprising a first screen area for displaying the first decoded signal and a second screen area for displaying the second decoded signal.

3. The system of claim 2, wherein when the first screen area displays the first decoded signal the second screen area displays the last received frame of the second decoded signal, and when the second screen area displays the second decoded signal the first screen area displays the last received frame of the first decoded signal.

4. The system of claim 3, wherein the first screen area is inside the second screen area.

5. The system of claim 3, wherein the first screen area and the second screen area are independent of each other.

6. The system of claim 3, wherein the displaying device further comprises a focus, for selectively highlighting the first screen area or the second screen area in order to send the command signal.

7. The system of claim 6, wherein the focus is moved between the first screen area and the second screen area according to a user command.

8. The system of claim 6, wherein the focus is moved between the first screen area and the second screen area at a predetermined time.

9. The system of claim 8, wherein the predetermined time is set according to a user command.

10. The system of claim 6, wherein the second data stream is a local media source and the focus is moved between the first screen area and the second screen area when the local media source is changed.

11. The system of claim 1, wherein the first data stream comes from a digital video broadcast (DVB) source and the second data stream comes from a digital media storage source.

12. The system of claim 1, further comprising:
a data buffer, coupled between the decoder and the first data stream, for buffering the first data stream to be decoded by the decoder.

13. The system of claim 12, wherein when the decoder stops outputting the first decoded signal and starts outputting the second decoded signal, the data buffer is enabled.

14. A system for selectively playing a live data stream or a stored data stream, the system comprising:
a decoder, coupled to both the live data stream and the stored data stream, for selectively decoding the live data stream to output a first decoded signal or decoding the stored data stream to output a second decoded signal according to a command signal; and
a data buffer, coupled between the decoder and the live data stream, for buffering the live data stream to be decoded by the decoder.

15. A method for selectively playing a first data stream or a second data stream, the method comprising:
selectively decoding the first data stream to output a first decoded signal or decoding the second data stream to output a second decoded signal according to a command signal;
outputting a first video signal or a second video signal corresponding to the first decoded signal or the second decoded signal respectively; and
buffering a last frame of the first video signal when the second video signal is output, and buffering a last frame of the second video signal when the first video signal is output.

16. The method of claim 15, wherein the step of outputting the first video signal or the second video signal corresponding to the first decoded signal or the second decoded signal respectively further comprises:
providing a first screen area for displaying the first video signal; and
providing a second screen area for displaying the second video signal.

17. The method of claim 16, wherein the step of buffering a last frame of the first video signal when the second video signal is output and buffering a last frame of the second video signal when the first video signal is output further comprises:
displaying the buffered last frame of the first video signal on the first screen area when the second video signal is displayed; and
displaying the buffered last frame of the second video signal on the second screen area when the first video signal is displayed.

18. The method of claim 17 wherein the step of buffering a last frame of the first video signal when the second video signal is output, and buffering a last frame of the second video signal when the first video signal is output further comprises:
providing a focus for selectively highlighting the first screen area or the second screen area in order to send the command signal.

19. The method of claim 15 wherein the first data stream comes from a digital video broadcast (DVB) source and the second data stream comes from a digital media storage source.

20. The method of claim 15 wherein the step of selectively decoding the first data stream to output the first decoded signal further comprises:
buffering the first data stream before decoding.

21. The method of claim 26 wherein the step of selectively decoding the first data stream to output the first decoded signal further comprises:
enabling buffering of the first data stream when the second decoded signal is outputted.
